(19) United States
(12) Patent Application Publication
(10) Pub. No.: US 2015/0085487 A1
(43) Pub. Date: Mar. 26, 2015

(54) OPTICAL SEMICONDUCTOR BASED ILLUMINATING APPARATUS

(71) Applicant: POSCO LED COMPANY LTD., Seongnam-si (KR)

(72) Inventors: Kyung Min Yun, Seongnam-si (KR); Seung Ki Kim, Seongnam-si (KR); Su Woon Lee, Seongnam-si (KR)

(21) Appl. No.: 14/506,276

(22) Filed: Oct. 3, 2014

Related U.S. Application Data
(62) Division of application No. 13/482,822, filed on May 29, 2012.

(30) Foreign Application Priority Data
Oct. 10, 2011 (KR) 10-2011-0103259
Oct. 21, 2011 (KR) 10-2011-0108062
Nov. 10, 2011 (KR) 10-2011-0116739

(51) Int. Cl. F21V 29/00; F21V 31/03

(52) U.S. Cl. CPC F21V 29/2212; F21V 31/03; F21V 29/006; F21Y 2101/02
USPC 362/249.01

(57) ABSTRACT

Disclosed herein is an optical semiconductor based illuminating apparatus including light emitting modules including at least one semiconductor optical device; and a housing enclosing one side surface of at least one of the light emitting modules. This optical semiconductor based illuminating apparatus may promote convenience for checking and repairing, simply perform separation and fastening, have excellent waterproofing characteristics and durability, prevent accidents such as short circuit and electric shock improve heat radiation performance, prevent introduction of foreign materials, be easily cleaned and maintained, reliably provide power of a main power line to a plurality of light emitting modules, and utilize a space and secure reliability of a product regardless of a size and a shape of a power supply embedded therein.

### CROSS-REFERENCE TO RELATED APPLICATIONS

This application is a divisional of U.S. patent application Ser. No. 13/482,822, filed on May 29, 2012, and claims the benefit of and priority from Korean Patent Application No. 10-2011-0103259, filed on Oct. 10, 2011, Korean Patent Application No. 10-2011-0108062, filed on Oct. 21, 2011, and Korean Patent Application No. 2011-0116739, filed on Nov. 10, 2011, which are hereby incorporated by reference for all purposes as if fully set forth herein.

### BACKGROUND OF THE INVENTION

1. Field of the Invention

The present invention relates to an optical semiconductor based illuminating apparatus.

2. Discussion of the Background

An optical semiconductor such as a light emitting diode (LED) is one of the components that have been recently spotlighted widely as an illuminating apparatus since it has lower power consumption, a longer lifespan, more excellent durability, and significantly higher brightness as compared with an incandescent lamp and a fluorescent lamp.

Particularly, an illuminating apparatus using the optical semiconductor as a light source has been recently used for illumination, security, or the like. Therefore, the illuminating apparatus should be conveniently assembled and configured. In addition, since the illuminating apparatus is used in a state in which it is exposed to the air, a waterproofing property should be maintained and measures should be taken against accidents such as short circuit and electric shock.

In addition, the illuminating apparatus using the optical semiconductor as a light source should have a structure in which components may be instantly replaced or repaired at the time of fault generation or malfunction.

In the illuminating apparatus using the optical semiconductor as a light source, as wattage increases or decreases, the number of products in the module form described above increases or decreases. In the case in which a plurality of products are embedded in the illuminating apparatus, when a fault occurs in each product, the entire illuminating apparatus cannot but be disassembled and reassembled.

In addition, the illuminating apparatus using the optical semiconductor as a light source includes a heat sink mounted in order to improve heat radiation performance and generally exposed to the air in order to promote a heat radiation effect. However, the heat sink is polluted by excrement of birds that tend to sit down at a high place, such that the heat sink looks bad in view of an appearance.

Meanwhile, an illuminating apparatus using a semiconductor device such as a light emitting diode (LED) as a light source has been mainly used as an illuminating apparatus requiring a high light output, such as a factory lamp, a street lamp, or a security lamp. This illuminating apparatus generates a large amount of heat at the time of a light emitting operation of a light emitting module including a semiconductor optical device.

In implementing this illuminating apparatus, a distributor for distributing power lines from a main power line from a power supply to a plurality of light emitting modules is also required.

The distributor as described above should include a distributor body provided at one side thereof and connected to the main power line and require a plurality of distribution lines extended from the distributor body.

Therefore, this distributor has a structure in which the plurality of distribution lines are branched and led from the distributor body. In this structure, a waterproofing problem of the distribution lines at distribution positions has been raised.

### SUMMARY OF THE INVENTION

The present invention provides an optical semiconductor based illuminating apparatus capable of promoting convenience for checking and repairing, simply performing separation and fastening, having excellent waterproofing characteristics and durability, and preventing accidents such as short circuit and electric shock.

Further, the present invention provides an optical semiconductor based illuminating apparatus capable of improving heat radiation performance.

Further, the present invention provides an optical semiconductor based illuminating apparatus capable of preventing introduction of foreign materials and being easily cleaned and maintained.

Further, the present invention provides an optical semiconductor based illuminating apparatus capable of reliably providing power of a main power line to a plurality of light emitting modules.

Further, the present invention provides an optical semiconductor based illuminating apparatus capable of utilizing a space and securing reliability of a product regardless of a size and a shape of a power supply embedded therein.

According to an exemplary embodiment of the present invention, there is provided an optical semiconductor based illuminating apparatus including: light emitting modules including at least one semiconductor optical device; and a housing enclosing one side surface of at least one of the light emitting modules.

The housing may be separated into a plurality of components.

The light emitting module may include: a heat sink part including the semiconductor optical device and disposed in the housing; and an optical cover coupled to the heat sink part.

The housing may include an outer frame enclosing one side surface of at least one of the light emitting modules.

The housing may further include a support having the outer frame slidably coupled thereto.

The housing may further include fixing plates having edges of both end portions fixed to facing surfaces of the outer frame, respectively, and embedded in the outer frame to fix both edges of the light emitting module, respectively.

The light emitting modules may be disposed between the fixing plates while forming one or more rows and columns.

The heat sink part may include: a heat radiation plate having at least one semiconductor optical device formed thereon; and a plurality of heat radiation fins formed on one surface of the heat radiation plate.

The heat sink part may include: a heat radiation plate having at least one semiconductor optical device formed thereon; a plurality of heat radiation thin plates disposed on the heat radiation plate; and heat pipes penetrating through the plurality of heat radiation thin plates to thereby be connected to the heat radiation plate and forming internal channels.

The heat sink part may include a wiring path formed by a pair of partition walls protruded from the heat radiation plate.

The heat sink part may further include a connection terminal mounted on the heat radiation plate forming the wiring path to thereby be electrically connected to the semiconductor optical device.

The heat sink part may further include: first grooves depressed in facing surfaces of the pair of partition walls, respectively; and an auxiliary cover having both end portions detachably coupled to the first grooves to cover a lower portion of the wiring path.

The respective connection terminals of the heat sink parts adjacent to each other may be connected to each other by a detachable connector.

One or more light emitting modules having the same size and shape may be disposed so as to be in parallel with each other in the housing.

A plurality of light emitting modules may be disposed so as to be in parallel with the fixing plates.

A plurality of light emitting modules may be disposed so as to be perpendicular to the fixing plates.

The auxiliary cover may include: a cover piece covering the wiring path while contacting edges of upper end portions of the partition walls; and auxiliary hooks protruded from a lower surface of the cover piece in a length direction of the cover piece and having end portions coupled to the first grooves.

The auxiliary cover may include: a cover piece contacting edges of upper end portions of the partition walls of the heat sink parts disposed in plural so as to cover the wiring path formed by the partition walls; and auxiliary hooks protruded from a lower surface of the cover piece in a length direction of the cover piece and having end portions coupled to a plurality of first grooves formed in the plurality of partition walls.

The outer frame of the housing may include side frames having second grooves formed in a length direction thereof and having a shape corresponding to those of fixing bars protruded on both side surfaces of the support.

The outer frame may further include a side bracket having a third groove formed at an upper portion of an inner side surface thereof in the length direction, a step formed at a lower portion of the inner side surface thereof, and fixing bars formed on an outer side surface thereof and corresponding to the second grooves to thereby be coupled to the side frame.

The outer frame may further include a connection frame having fixing pieces protruded from both end portions thereof, respectively, and having a shape corresponding to that of a coupling space formed by the fixing bars and the second grooves.

The optical semiconductor based illuminating apparatus may further include a cover covering an upper portion of the light emitting module and having both end portions coupled to the outer frame.

The cover may include: a plate covering the upper portion of the light emitting module; connection pieces extended from both end portions of the plate and bent toward the outer frame; and catching hooks extended from end portions of the connection pieces to thereby be detachably coupled to the third grooves.

The cover may further include reinforcing structures protruded inwardly along connection portions between the plate and the connection pieces.

The cover may further include step parts formed at lower portions of the connection pieces so as to be stepped and having upper end portions seated on edges of an upper portion of the outer frame, and the catching hooks may be formed at lower end portions of the step parts.

The reinforcing structure may include: a body protruded from the connection portion between the plate and the connection piece; and a hollow part cut inwardly in a length direction of the body and formed in a cylindrical shape at the center of the body to thereby be expanded or contracted according to elastic deformation of the connection piece.

The light emitting modules adjacent to each other or the outermost light emitting module and the housing may be disposed so as to be spaced apart from each other.

The housing may further include: a cover having both end portions detachably coupled to facing edges of the housing, respectively, while being deformed, so as to cover an upper portion of the light emitting module; and vent units formed in the cover to discharge heat generated from the light emitting module.

The cover may include: connection pieces extended from both end portions of a plate covering the upper portion of the light emitting module and bent toward the housing to thereby be elastically deformed so as to approach each other or be spaced apart from each other while facing each other; and catching hooks extended from end portions of the connection pieces to thereby be detachably coupled to an upper portion of an inner side surface of the housing, and the vent unit may be formed in the plate.

The plate may further include a plurality of grooves formed in a direction corresponding to a direction in which the plurality of light emitting modules embedded in the housing are disposed, and the vent unit may be formed between the grooves adjacent to each other.

The vent unit may include vent holes formed at equidistance so as to penetrate through the plate in the direction in which the light emitting modules are disposed.

The vent holes may penetrate through the plate in a slit shape so as to be in parallel with a plurality of heat radiation fins protruded from the light emitting module and disposed at equidistance.

The vent holes may penetrate through the plate in a slit shape so as to be perpendicular to a plurality of heat radiation fins protruded from the light emitting module and disposed at equidistance.

The vent holes may penetrate through the plate at positions corresponding to positions at which the semiconductor optical devices included in the light emitting module are disposed.

The vent unit may further include a vent guide extended from an edge of one side of the vent hole upwardly of the plate to cover an upper portion of the vent hole and having an outlet provided at the other side thereof.

An edge of the outlet side of the vent guide may be disposed on a virtual straight line extended in a direction perpendicular to an edge of the other side of the vent hole.

An edge of the outlet side of the vent guide may pass through a virtual straight line extended in a direction perpendicular to an edge of the other side of the vent hole and be then extended to the plate in the vicinity of the edge of the other side of the vent hole.

The vent unit may include a plurality of vent holes penetrating through the plate of the cover covering the upper portion of the light emitting module.

The optical semiconductor based illuminating apparatus may further include a distributor distributing power received from a main power line to the light emitting modules.

The distributor may include: a distributor body connected to the main power line; a cable jacket extended from the other side of the distributor body by a predetermined length; and a plurality of distribution cables led from the distributor body, passing through the cable jacket, and then connected to each of the plurality of light emitting modules.

The distributor body may include: a power distribution printed circuit board having terminals connected to the main power line and the distribution cables and a power distribution circuit connected to the terminals; and a molding part formed to cover the entire power distribution PCB.

The cable jacket may be extended from an inner portion of the molding part to an outer portion thereof.

The housing may include an auxiliary space separated from a main space by a partition wall, the distributor body may be positioned at the auxiliary space, the cable jacket may pass through the partition wall and be then extended into the main space, and the distribution cables may be branched from the cable jacket in the main space.

The cable jacket may be assembled to a cable gland installed at the partition wall.

The plurality of light emitting modules may include a heat sink provided at the rear thereof, and the heat sink may include a path at which at least one of the distribution cables is positioned and heat radiation fins formed in the vicinity of the path.

The plurality of light emitting modules may be disposed so as to be in parallel with each other, such that the paths are continuously connected to each other.

The distribution cables may have different lengths.

The distributor may receive direct current power from a switch mode power supply (SMPS) connected to the main power line, wherein the SMPS is positioned inside the housing.

The distributor may receive direct current power from an SMPS connected to the main power line, wherein the SMPS is positioned outside the housing.

The housing may include: a pair of rails formed on an inner surface of the support; a power supply (hereinafter, referred to as an SMPS) disposed at an upper portion of the rail; and a bracket having both end portions reciprocating along the pair of rails and fixing the SMPS.

The housing may further include a seat jaw disposed between the pair of rails and having the SMPS seated thereon.

The rails may be formed along both edges of the seat jaw.

The bracket may include: a first piece contacting an upper surface of the SMPS; second pieces extended from both end portions of the first piece, respectively; and third pieces extended from end portions of the second pieces, respectively, to contact the rails.

The housing may further include fixtures formed on an inner surface of the support and fixing both sides of one end portion of the SMPS.

The bracket may further include at least one bolt detachably coupled to the first piece to contact or be spaced apart from the upper surface of the SMPS.

The fixture may include a pair of blocks detachably coupled to the inner surface of the support and having a shape corresponding to those of cut parts formed at both sides of one end portion of the SMPS, respectively.

The fixture may include: fourth pieces that are in parallel with the inner surface of the support and disposed at both sides of one end portion of the SMPS, respectively; and blocking walls extended to an inner side surface of the support along two edges of the fourth pieces meeting each other and contacting both sides of one end portion of the SMPS.

In addition, a ‘semiconductor optical device’ described in the claims and the detailed description means a device such as a light emitting diode chip, or the like, including or using an optical semiconductor.

This ‘semiconductor optical device’ may include a package level of device in which various kinds of optical semiconductors including the above-mentioned light emitting diode chip is included.

### BRIEF DESCRIPTION OF THE DRAWINGS

FIGS. 1 and 2 are perspective views showing a process of separating an optical semiconductor based illuminating apparatus according to an exemplary embodiment of the present invention;

FIG. 3 is an exploded perspective view showing the entire configuration of the optical semiconductor based illuminating apparatus according to the exemplary embodiment of the present invention;

FIG. 4 is a partially cut-away perspective view showing a coupling relationship between a light emitting module and a housing which are main parts of the optical semiconductor based illuminating apparatus according to the exemplary embodiment of the present invention;

FIG. 5 is a perspective view showing a heat sink part and an auxiliary cover of the light emitting module which is the main part of the optical semiconductor based illuminating apparatus according to the exemplary embodiment of the present invention;

FIG. 6 is a view viewed from the point A of FIG. 2;

FIGS. 7 and 8 are views showing a process of separating a cover from an upper portion of the light emitting module which is the main part of the optical semiconductor based illuminating apparatus according to the exemplary embodiment of the present invention, wherein FIG. 7 is a conceptual diagram showing a state before separating the cover from the upper portion of the light emitting module; and

FIG. 8 is a conceptual diagram showing a process of separating the cover from the upper portion of the light emitting module.

FIG. 9 is a perspective view showing the entire structure of the optical semiconductor based illuminating apparatus according to the exemplary embodiment of the present invention;

FIG. 10 is a view viewed from the point A of FIG. 9;

FIGS. 11 and 12 are cross-sectional views taken along the line B-B′ of FIG. 1;

FIGS. 13 to 15 are views showing a cover which is a main part of an optical semiconductor based illuminating apparatus according to another exemplary embodiment of the present invention;

FIG. 16 is a plan view showing a state in which the cover of the housing is omitted in the illuminating apparatus so that the rear of the light emitting module may be viewed;

FIG. 17 is a partially cut-away view of a distributor shown in FIG. 16;

FIG. 18 is a conceptual diagram describing an illuminating apparatus according to another exemplary embodiment of the present invention;

FIG. 19 is a conceptual diagram showing a coupling relationship between a bracket and an SMPS which are main parts of the optical semiconductor based illuminating apparatus according to the exemplary embodiment of the present invention;

FIG. 20 is a cross-sectional view viewed from the point X of FIG. 19; and

FIGS. 21 and 22 are partially exploded perspective views showing a state in which the SMPS is coupled to a fixture which is a main part of the optical semiconductor based illuminating apparatus according to various exemplary embodiments of the present invention.

### DETAILED DESCRIPTION OF THE ILLUSTRATED EMBODIMENTS

Hereinafter, exemplary embodiments of the present invention will be described in detail with reference to the accompanying drawings.

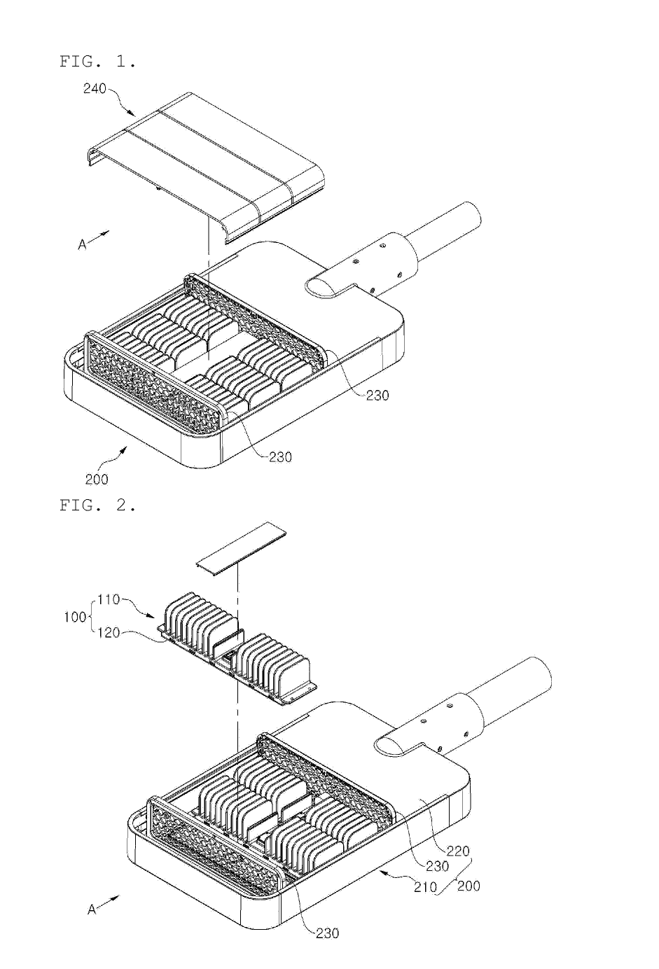

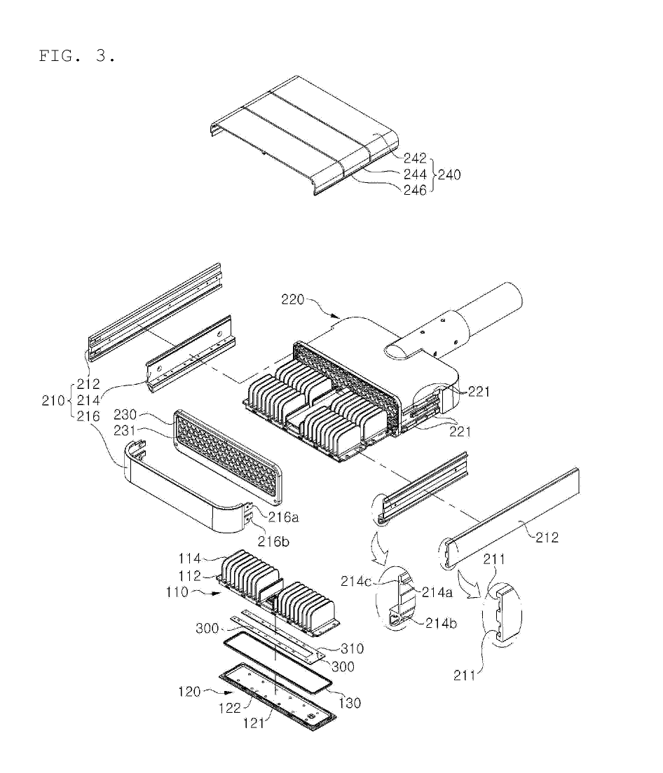

FIGS. 1 and 2 are perspective views showing a process of separating an optical semiconductor based illuminating apparatus according to an exemplary embodiment of the present invention; FIG. 3 is an exploded perspective view showing the entire configuration of the optical semiconductor based illuminating apparatus according to the exemplary embodiment of the present invention; and FIG. 4 is a partially cut-away perspective view showing a coupling relationship between a light emitting module and a housing which are main parts of the optical semiconductor based illuminating apparatus according to the exemplary embodiment of the present invention.

The optical semiconductor based illuminating apparatus according to the present invention may includes a housing 200 mounted with at least one light emitting module 100 including a semiconductor optical device 300, having opened upper and lower surfaces, and enclosing an edge of the light emitting module 100, as shown.

Therefore, in the case in which the light emitting module 100 malfunctions or is not operated, a worker may separate only a corresponding light emitting module 100 from the housing 200 without separating the entire apparatus due to structural characteristics of the light emitting module 100 detachably coupled to the housing 200 in a vertical direction of the housing 200.

A process of separating the light emitting module 100 will be simply described. When a cover 240 to be described below is separated from the housing 200 as shown in FIG. 1, a light emitting module that is out of order or malfunctions among at least one light emitting modules 100 disposed between fixing plates 230 to be described below is separated from the housing 200 as shown in FIG. 2, thereby making it possible to perform simple repairing and replacement without extensively disassembling the entire apparatus including the housing 200.

According to the present invention, the example as described above may be applied, and various examples as follows may also be applied.

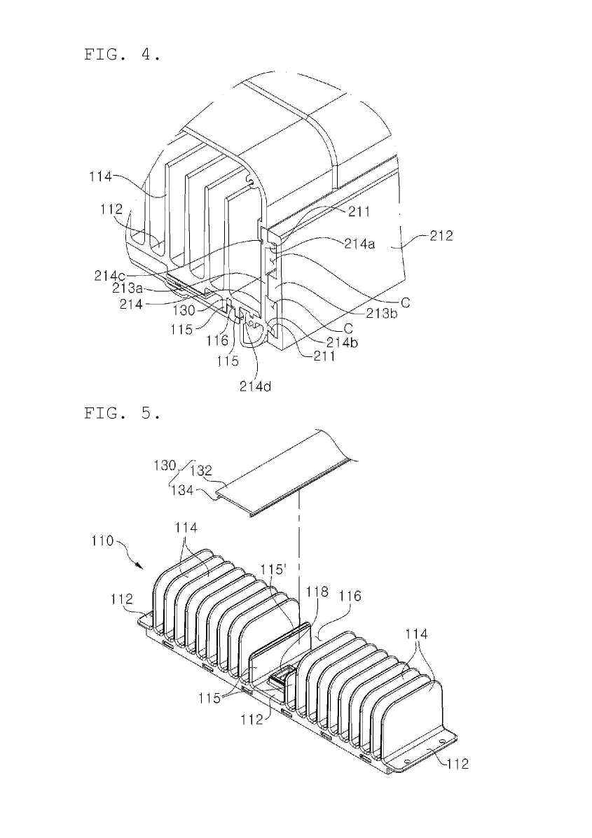

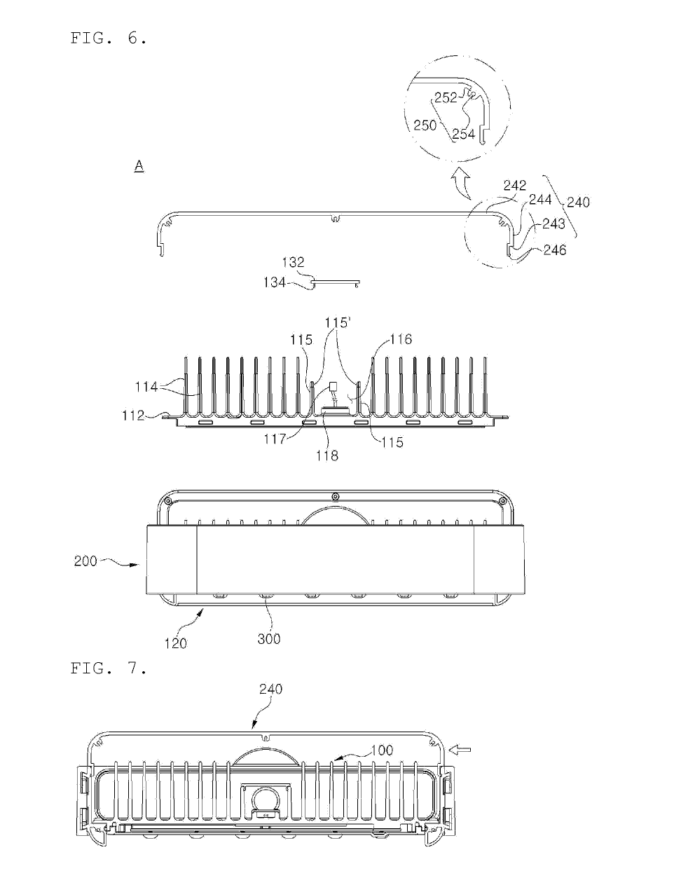

For reference, FIG. 5 is a perspective view showing a heat sink part and an auxiliary cover of the light emitting module which is the main part of the optical semiconductor based illuminating apparatus according to the exemplary embodiment of the present invention; FIG. 6 is a view viewed from the point A of FIG. 2; FIGS. 7 and 8 are views showing a process of separating a cover from an upper portion of the light emitting module which is the main part of the optical semiconductor based illuminating apparatus according to the exemplary embodiment of the present invention, wherein FIG. 7 is a conceptual diagram showing a state before separating the cover from the upper portion of the light emitting module; and FIG. 8 is a conceptual diagram showing a process of separating the cover from the upper portion of the light emitting module.

First, the light emitting module 100 may include the semiconductor optical device 300 as described above and have a structure in which an optical cover 120 is coupled to a heat sink part 110.

Here, an example in which one or more light emitting modules 100 having the same size and shape are disposed so as to be in parallel with each other in the housing 200 as shown may be applied. In addition, although not particularly shown, an example in which the light emitting modules 100 are disposed in the housing 200 while forming one or more rows and columns may also be applied.

In addition, when one or more light emitting modules 100 having the same size and shape are disposed so as to be in parallel with each other as shown, the light emitting modules 100 adjacent to each other or the outermost light emitting module 100 and the housing 200 are disposed so as to have a predetermined interval therebetween, thereby making it possible to promote ventilation and heat radiation effects.

The heat sink part 110 may have the semiconductor optical device 300 disposed thereat and be seated on a lower portion of an inner side surface of the housing 200 to discharge heat generated from the semiconductor optical device 300, and the optical cover 120 may be detachably coupled to the heat sink part 110 along an edge of the heat sink part 110, protect the semiconductor optical device 300, and additionally perform a light diffusion function.

The heat sink part 110 may have a structure in which heat radiation fins 114 are protruded on a heat radiation plate 112, a wiring path 116 is formed at the center of the heat radiation plate 112 on which the heat radiation fins 114 are protruded, and a connection terminal 118 electrically connected to the semiconductor optical device 300 is formed on the heat radiation plate 112 at a portion at which the wiring path 116 is formed.

That is, the heat radiation plate 112 has the semiconductor optical device 300 disposed thereon, both end portions seated on the housing 200, and the optical cover 120 coupled thereto.

A plurality of heat radiation fins 114 may be protruded from both end portions of the heat radiation plate 112 toward the center thereof on the heat radiation plate 112 to increase a heat transfer area, thereby promoting a heat radiation effect.

In addition to a structure in which the heat radiation fins 114 having a simple flat panel shape are disposed at equidistance as shown, an application and a design change in which the heat radiation fins 114 having various shapes are disposed in various patterns on the heat radiation plate 112 are obvious to those skilled in the art. Therefore, an additional description thereof will be omitted.

The wiring path 116 is formed by a pair of partition walls 115 and 115 protruded from a central portion of the heat radiation plate 112, and the connection terminal 118 is mounted on the heat radiation plate 112 forming the wiring path 116 to thereby be electrically connected to the semiconductor optical device 300.

Here, although the case in which the wiring path 116 is formed at the center of the heat radiation plate 112 is shown in the accompanying drawings, the wiring path 116 is not necessarily disposed at the center of the heat radiation plate 112 according to a kind or an internal structure of various illuminating apparatuses.

Here, a plurality of heat sink parts 110 may be mounted in the housing 200 as shown, an external power supply (not shown) of the housing 200 and the connection terminal 118 may be electrically connected to each other, and the respective connection terminals 118 of the heat sink parts 110 adjacent to each other may be connected to each other by a detachable connector 117 as shown in FIG. 6.

For example, in the case in which one of the light emitting modules 100 disposed in three rows malfunctions (See FIG. 2), a process of removing only the corresponding light emitting module 100, connecting the connectors 117 formed at both of the remaining light emitting modules 110 to each other, and connecting them to the external power of the housing 200 is performed, thereby making it possible to perform emergency measures until the corresponding light emitting module 100 is replaced by a new component.

In addition, the heat sink part 110 may be provided with an auxiliary cover 130 having both end portions detachably coupled to first grooves 115′ and 115′ depressed in facing surfaces of the pair of partition walls 115 and 115, respectively, to cover a lower portion of the wiring path 116, in order to prevent accidents such as short circuit and electric shock, or the like, due to penetration of moisture, or the like, into the electric wires and the connectors 117 disposed along the wiring path 116.

More specifically, the auxiliary cover 130 may have a structure in which auxiliary hooks 134 and 134 are protruded from a lower surface of a cover piece 132 covering the wiring path 116 while contacting edges of upper end portions of the partition walls 115 and 115 in a length direction of the cover piece 132 and have end portions coupled to the first grooves 115′ and 115′.

In addition, the auxiliary cover 130 includes the cover piece 132 manufactured corresponding to lengths of the edges of the upper end portions of the partition walls 115 and 115 of the heat sink parts 110 disposed in plural so as to cover the wiring path 116 formed by the partition walls 115 and 115, such that a plurality of light emitting modules 100 may be managed.

Further, although not particularly shown, an example of a structure of the heat sink part 110 in which a plurality of heat radiation thin plates are disposed on the heat radiation plate 112 and heat pipes allowing these heat radiation thin plates and the heat radiation plate 112 to be in communication with each other is formed to increase a heat radiation effect may also be applied.

Meanwhile, the housing 200, which encloses an edge of the light emitting module 100 as described above, may have a structure in which at least one light emitting module 100 is disposed between the fixing plates 230 disposed while traversing an internal space formed by an outer frame 210 coupled to both sides of a support 220.

That is, the outer frame 210 serves as a partition wall enclosing the edge of the light emitting module 100, the support 220 has the outer frame 210 slidably coupled thereto and connected to an external power supply, the fixing plates 230 have edges of both end portions fixed to facing surfaces of the outer frame 210, respectively, and are embedded in the outer frame 210 to fix both edges of the light emitting module 100, respectively.

The fixing plate 230 includes a plurality of holes 231 formed therein as shown to increase a heat transfer area, thereby making it possible to promote heat discharging in the housing 200.

Meanwhile, a structure of the outer frame 210 of the housing 200 will be described in more detail with reference to a cut portion of FIG. 4. The outer frame 210 may have a structure in which side frames 212 are slidably coupled to both sides of the support 220, side brackets 214 are also slidably coupled to inner sides of the side frames 212, and both end portions of a connection frame 216 are coupled to a coupling space C formed by the side frames 212 and the side brackets 214.

That is, the side frames 212 includes second grooves 211 formed in a length direction thereof and having a shape corresponding to those of fixing bars 221 protruded on both side surfaces of the support 220 and are fixed to the support 220 by sliding the second grooves 211 on the bars 221.

In addition, the side bracket 214 includes fixing bars 214a and 214b which are protruded on an outer side surface thereof and have a shape corresponding to that of the bar 221, a third groove 214c which is formed at an upper portion of an inner side surface thereof in the length direction, and a step 214d which is formed at a lower portion of the inner side surface thereof and on which an edge of the light emitting module 100 is seated, and is fixed to the side frame 212 by sliding the fixing bars 214a and 214b into the second grooves 211.

Further, the connection frame 216 includes fixing pieces 216a and 216b which are protruded from both end portions thereof, respectively, and have a shape corresponding to that of the coupling space C formed by the fixing bars 214a and 214b and the second grooves 211 to connect end portions of the side frames 212 each coupled to both sides of the support 220 to each other.

Therefore, as described above, this coupling structure of the outer frame 210 allows a fastener such as a bolt, or the like, to be coupled from an inner side of the outer frame 210 formed by slidably coupling each component, that is, the side frames 212, the side brackets 214, and the connection frame 216 to each other, thereby making it possible to maintain an appearance and prevent defects such as rust generation, a crack, and the like.

Here, the fixing bars 214a and 214b may be protruded at upper and lower portions of the side bracket 214, respectively, wherein the upper fixing bar 214a may be formed to be inclined upwardly and the lower fixing bar 214b may be formed to be inclined downwardly.

Here, the second grooves 211 of the side frame 212 are also formed to have a shape corresponding to those of the upper and lower fixing bars 214a and 214b, thereby making it possible to maintain firmly fastening force of the outer frame 210 itself and also maintain durability for vertical load, shearing stress, and impact in a vertical direction in which the outer frame 210 is opened.

In addition, the coupling space C formed by the fixing bars 214a and 214b and the second grooves 211 may be bisected by allowing a first support protrusion 213a protruded from the side bracket 214 and a second support protrusion 213b protruded from the side frame 212 to contact each other, so as to further improve structural strength, and the fixing pieces 216a and 216b may have a shape corresponding to that of the bisected coupling space C.

Further, the outer frame 210 may be mounted with the cover 240 having both end portions detachably coupled to the third groove 214c and covering an upper portion of the light emitting module 100 in order to protect the light emitting module 100.

Therefore, the cover 240 may be detachably coupled to the outer frame 210 in the vertical direction with respect to opened upper and lower portions of the outer frame 210.

More specifically, the cover 240 may include connection pieces 244 extended from both end portions of a plate 242 covering the upper portion of the light emitting module 100 and bent toward the outer frame 210 and catching hooks 246 extended from end portions of the connection pieces 244 to thereby be detachably coupled to the third grooves 214c.

That is, in the cover 240, each of the connection pieces 244 extended from both end portions of the plate 242 is elastically deformed so as to approach each other or be spaced apart from each other, thereby making it possible to promote convenience for separation and fastening.

In addition, the cover 240 may further include step parts 243 formed at lower portions of the connection pieces 244 so as to be stepped and having upper end portions seated on edges of an upper portion of the outer frame 210, and the catching hooks 246 may be formed at lower end portions of the step parts 243.

The step parts 243 allow the connection pieces 244 to be accurately seated in the housing 200, specifically, on the edges of the upper portion of the outer frame 210 while allowing the connection pieces 244 to be elastically deformed, thereby assisting in determining a position at which the cover 240 is accurately coupled to the housing 200.

In addition, the cover 240 may further include reinforcing structures 250 protruded inwardly along connection portions between the plate 242 and the connection pieces 244, in addition to the above-mentioned step part 243.

The third grooves 214c allow the connection pieces 244 to be accurately seated on the housing 200, specifically, the edges of the outer frame 210, more specifically, edges of an upper portion of the side bracket 214 while allowing the connection pieces 244 to be elastically deformed, thereby assisting in determining a position at which the cover 240 is accurately coupled to the housing 200.

The reinforcing structure 250 may serve to maintain durability for repeated elastic deformation of the connection piece 244 with respect to the plate 242 and provide a coupling space with the fixing plate 230.

That is, both end portions of the reinforcing structure 250 are detachably coupled to the fixing plate 230 embedded in the housing 200 by a fastener such as a bolt, or the like, while fixing both edges of the light emitting module 100, respectively.

In addition, the catching hook 246 is formed at a lower end portion of the step part 243, and a distance from the catching hook 246 to the step part 243 corresponds to a distance from the edge of the upper end portion of the side bracket 214 to the third groove 214c.

More specifically, the reinforcing structure 250 includes a hollow part 254 cut inwardly in a length direction of a body 252 protruded from the connection portion between the plate 242 and the connection piece 244 and formed in a cylindrical shape at the center of the body 252.

Here, the hollow part 254 of the body 252 may be expanded or contracted according to the elastic deformation of the connection piece 244.

Therefore, when a worker applies force in a direction of an arrow as transparently shown in FIG. 7 in order to separate the cover 240, the cover 240 may be easily separated upwardly of the light emitting module 100 as shown in FIG. 8.

In addition to the method of separating the cover 240 as described above, although not particularly shown, an example in which the worker simultaneously applies force from both sides of the cover 240 to separate the cover 240 upwardly of the light emitting module 100 may also be applied.

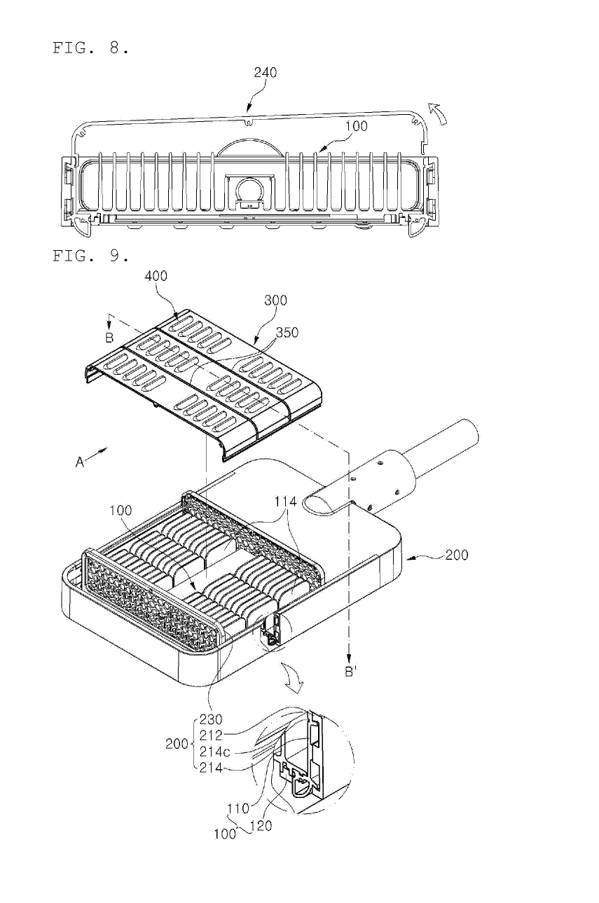

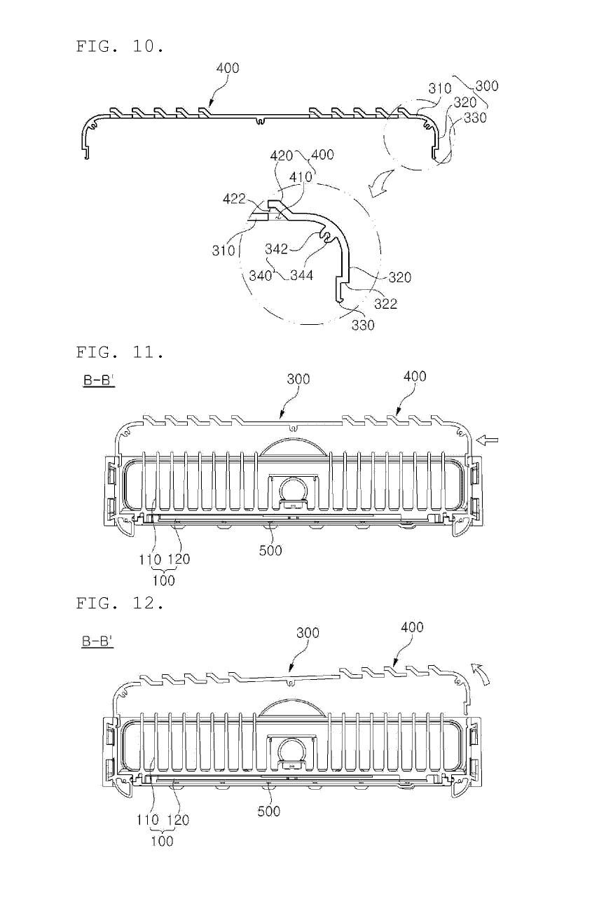

Meanwhile, the optical semiconductor based illuminating apparatus according to the present invention may have a structure in which at least one light emitting module 100 including a semiconductor optical device 500 (See FIG. 11) is mounted in a housing 200, both end portions of a cover 300 are detachably coupled to facing edges of the housing, respectively, while being deformed, so as to cover an upper portion of the light emitting module 100, and the cover 300 is provided with vent units 400 to discharge heat generated from the light emitting module 100 as shown in FIG. 9.

Therefore, the worker may easily separate the cover from the housing 200 due to structural characteristics of the cover 300 capable of being deformed even through slight force is applied from one side of the cover 300 to the cover 300.

In addition, the vent unit 400 may improve heat radiation performance simultaneously with preventing introduction of foreign materials.

According to the present invention, the example as described above may be applied, and various examples as follows may also be applied.

First, the light emitting module 100 has a structure in which a heat sink part 110 including the semiconductor optical device 500 is covered by an optical cover 120 as shown in a portion cut in FIG. 9.

In the housing 200 in which the light emitting module 100 is embedded as described above, the light emitting modules 100 are mounted between a side frame 212 and fixing plates 230, and both end portions of a cover 300 to be described below are detachably coupled to third grooves 214c.

The side frame 212 serves as a partition wall enclosing an edge of the light emitting module 100.

The third grooves 214c are formed at an upper portion of an inner side surface of the side frame 212 so as to correspond to both end portions of the cover 300.

The fixing plates 230 are embedded in the side frame 212 so as to be perpendicular to a direction in which the third groove 214c are formed to fix both edges of the light emitting modules 100, respectively.

The fixing plates 230 are formed with a plurality of holes to increase a heat transfer area, thereby making it possible to improve a heat radiation effect in the housing 200.

The cover 300 has a structure in which both edges thereof contact facing edges of the fixing plates 230 exposed upwardly of the side frame 212.

Here, an upper end portion of the housing 200 may be provided with the third grooves 214c to which the cover 300 is detachably coupled and a lower end portion thereof may be provided with the side bracket 214 on which the edge of the light emitting module 100 is seated and which is coupled to an inner side surface of the side frame 212.

Meanwhile, the cover 300, which covers the upper portion of the light emitting module 100 as described above, has a structure in which connection pieces 320 are extended from both end portions of a plate 310 covering the upper portion of the light emitting module 100 and bent toward the housing 200 to thereby be elastically deformed so as to approach each other or be spaced apart from each other while facing each other, and catching hooks 330 are extended from end portions of the connection pieces 320 to thereby be detachably coupled to an upper portion of an inner side surface of the housing 200, that is, the third grooves 214c, as shown in FIG. 10.

Here, the cover 300 may further include steps 322 formed at lower portions of the connection pieces 320 so as to be stepped and having an upper end portion seated on edges of an upper portion of the housing 200, more specifically, edges of an upper portion of the side bracket 214 and reinforcing structures 340 protruded inwardly along connection portions between the plate 310 and the connection pieces 320.

The steps 322 allow the connection pieces 320 to be accurately seated on the housing 200, specifically, the edges of the side frame 212, more specifically, the edges of the upper portion of the side bracket 214 while allowing the connection pieces 320 to be elastically deformed, thereby assisting in determining a position at which the cover 300 is accurately coupled to the housing 200.

The reinforcing structure 340 may serve to maintain durability for repeated elastic deformation of the connection piece 320 with respect to the plate 310 and provide a coupling space with the fixing plate 230.

That is, both end portions of the reinforcing structure 340 are detachably coupled to the fixing plate 230 embedded in the housing 200 by a fastener such as a bolt, or the like, while fixing both edges of the light emitting module 100, respectively, the catching hook 330 is formed at a lower end portion of the step 322, and a distance from the catching hook 330 to the step 322 corresponds to a distance from the edge of the upper end portion of the side bracket 214 to the third groove 214c.

More specifically, the reinforcing structure 340 is cut inwardly in a length direction of a body 342 protruded from the connection portion between the plate 310 and the connection piece 320, wherein the body 342 has a hollow part 344 formed at the center thereof and having a cylindrical shape.

Here, the hollow part 344 of the body 342 may be expanded or contracted according to the elastic deformation of the connection piece 320.

Therefore, when a worker applies force in a direction of an arrow as transparently shown in FIG. 11 in order to separate the cover 300, the cover 300 may be easily separated upwardly of the light emitting module 100 as shown in FIG. 12.

In addition to the method of separating the cover 300 as described above, although not particularly shown, an example in which the worker simultaneously applies force from both sides of the cover 300 to separate the cover 300 upwardly of the light emitting module 100 may also be applied.

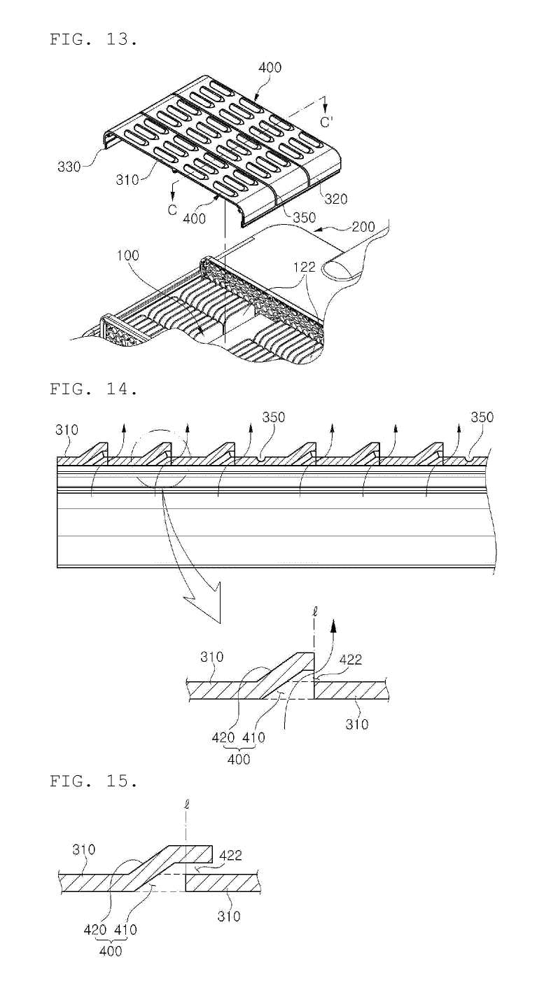

Meanwhile, the cover 300 may serve to cover the upper portion of the light emitting module 100 and prevent introduction of foreign materials as described above and be provided with at least one groove 350 depressed from a lower end portion of the connection piece 320 provided at one side of the plate 310 up to a lower end portion of the connection piece 320 provided at the other side of the plate 310 as shown in FIG. 13.

Here, the groove 350 may also be used in order to induce discharging of moisture in rainy weather.

Although not shown in detail in FIG. 13, the groove 350 may be inclined downwardly from the center of the plate 301 toward the connection pieces 320 of both sides thereof, thereby making it possible to improve a drain effect.

Further, although not particularly shown, the cover 300 may further have an inclination surface formed by bending the plate 310 so as to be gradually inclined downwardly from the center of the plate 310 toward the connection pieces 320 of both sides thereof in order to improve the drain effect.

Meanwhile, the cover 300 may be further provided with vent units 400 for discharging heat generated from the light emitting module 100 as shown in FIG. 13.

In the cover 300, the vent units 400, more specifically, vent holes 410 to be described below may be formed so as to be in parallel with each heat radiation fin in a direction in which a plurality of heat radiation fins configuring the heat sink part 110 are disposed as shown in FIGS. 9 to 12. Alternatively, an example in which vent holes 410 to be described below are formed in a direction perpendicular to the heat radiation fins as shown in FIGS. 13 to 15 may also be applied.

For reference, an arrow represented by a curved line indicates a movement direction of air.

Here, an example of a structure in which the vent unit 400 includes the vent holes 410 (See an enlarged portion of FIG. 10 and FIGS. 14 and 15) formed at equidistance so as to penetrate through the plate 310 of the cover 300 covering the upper portion of the light emitting module 100 may be applied.

Here, the vent holes 410 may have any area that is in the range of 1 to 90% of an area of the plate 310 and be disposed in various patterns.

Meanwhile, the vent unit 400 may further include a vent guide 420 extended from an edge of one side of the vent hole 410 upwardly of the plate 310 to cover an upper portion of the vent hole 410 and having an outlet 422 provided at the other side thereof, in order to block introduction of foreign materials from the outside while performing a heat radiation function, as shown.

Here, specifically, an example in which the vent holes 410 penetrate through the plate 310 in a slit shape (it may be inferred from a shape of the vent guide 420 that although not shown in FIGS. 9 to 12, the vent hole 410 has a slit shape in which a length thereof is larger than a width thereof) so as to be in parallel with the plurality of heat radiation fins protruded from the heat sink part 110 configuring the light emitting module 100 and disposed at equidistance may be applied.

Here, an example in which the vent holes 410 penetrates through the plates 310 at positions corresponding to positions at which the semiconductor optical devices 500 are disposed as shown in FIG. 12 may be applied.

In addition, an example in which the vent holes 410 penetrate through the plate 310 in a slit shape so as to be perpendicular to a plurality of heat radiation fins 122 protruded from the light emitting module and disposed at equidistance may also be applied, as shown in FIG. 13.

Here, an edge of the outlet 422 side of the vent guide 420 may be disposed on a virtual straight line l extended in a direction perpendicular to an edge of the other side of the vent hole 410, as shown in FIG. 14.

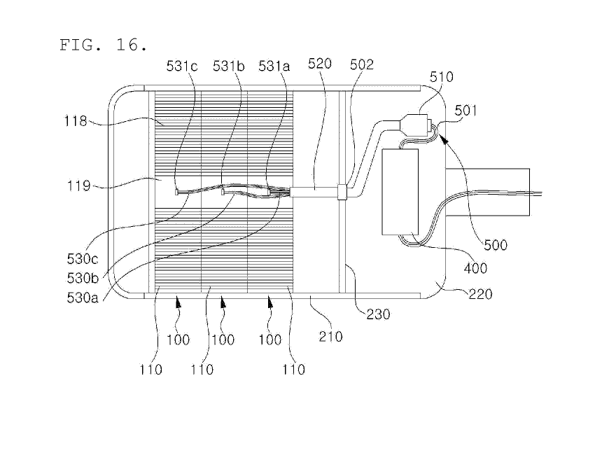

Meanwhile, an example in which the edge of the outlet 422 side of the vent guide 420 passes through the virtual straight line l extended in the direction perpendicular to the edge of the other side of the vent hole 410 and is then extended to the plate 310 in the vicinity of the edge of the other side of the vent hole 410 as shown in FIG. 15 may also be applied.

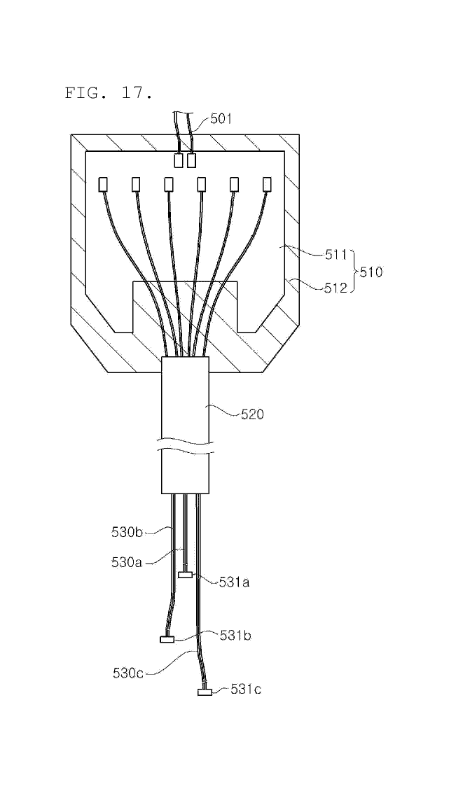

Meanwhile, FIG. 16 is a plan view showing a state in which the cover of the housing is omitted in the illuminating apparatus so that the rear of the light emitting module may be viewed; and FIG. 17 is a partially cut-away view of a distributor shown in FIG. 16.

The optical semiconductor based illuminating apparatus according to the present invention may include a plurality of light emitting modules 100 having the structure as described above.

As shown in FIGS. 16 and 17, the illuminating apparatus includes a box type support frame 220 and an outer frame 210 coupled to the box type support frame 220.

An inner portion of the outer frame 210 is provided with a space in which the plurality of light emitting modules 100, 100, and 100 are disposed so as to be in parallel with each other.

An inner portion of the support frame 220 may be provided with a power supply 400 (hereinafter, a switching mode power supply (SMPS) such as the SMPS.

The SMPS 400 is connected to an alternate current (AC) power line led from the outside in a state in which it is positioned in the support frame 220.

Each light emitting module 100 includes a heat sink 110 having a plurality of plate shaped heat radiation fins 118 formed integrally therewith at a side opposite to a side at which light is emitted.

The center of each heat sink 100 is provided with a cable path 119 in which the heat radiation fins 118 are not formed.

The cable paths 119 of each of the plurality of light emitting modules 100 are connected to each other at the rear of the heat sinks 110.

The cable paths 119 of all of the light emitting modules 100 are connected to each other at the rear of the heat sinks 110 to form a single long cable path.

According to the exemplary embodiment of the present invention, a distributor 500 receiving direct current (DC) power through a main power line extended from an output terminal of the SMPS 400 and distributing the DC power to the plurality of light emitting modules 100 is provided.

Referring to FIGS. 16 and 17, the distributor 500 includes a distributor body 510, an external cable jacket 520, and a plurality of distribution cables 530a, 530b, and 530c.

The distributor body 510 is connected to the main power line 501 at one side thereof and is connected integrally with the external cable jacket 520 at the other side thereof.

In addition, the plurality of distribution cables 530a, 530b, and 530c are installed so as to be led from the other side of the distributor body 510.

Here, the plurality of distribution cables 530a, 530b, and 530c pass through the external cable jacket 520 by a predetermined length section when or before they are led from the distributor body 510.

The external cable jacket 520 encloses the plurality of distribution cables 530a, 530b, and 530c in a state in which they are connected integrally with the distributor body 510.

Therefore, the plurality of distribution cables 530a, 530b, and 530c are enclosed by the external cable jacket 520 by a predetermined length from the distributor body 510, such that they are not exposed to the outside.

The plurality of distribution cables 530a, 530b, and 530c have different lengths so as to be connected to the light emitting modules 100, 100, and 100 disposed at different positions.

The plurality of distribution cables 530a, 530b, and 530c include connectors 531a, 531b, and 531c provided at a distal end thereof in order to be electrically connected to the light emitting modules 100, 100, and 100.

The distributor body 510 is positioned in the box type support frame 200.

The external cable jacket 520 is disposed to penetrate through a partition wall partitioning the box type support frame 200 and an installation space (hereinafter, referred to as a ‘light emitting module space’) of the light emitting modules 100, for example, the fixing plate 230 according to the present embodiment.

A through-hole of the partition wall is installed with a cable gland 502 to which the external cable jacket 520 is assembled.

The distribution cables 530a, 530b, and 530c are led from the external cable jacket 520 in the light emitting module space and connected to the light emitting modules 100, 100, and 100 disposed at different positions, respectively.

Since the external cable jacket 520 covers the distribution cables 530a, 530b, and 530c in a sealing structure in a predetermined length section, particularly, a predetermined length section in an environment requiring waterproofing, a risk such as disconnection, or the like, due to penetration of moisture may be blocked in advance.

As shown in FIG. 17, the distributor body 510 includes a power distribution printed circuit board (PCB) 511 and a molding part 512 formed to cover the entire power distribution PCB 511.

One end portion of the external cable jacket 520 is positioned in the molding part 512 to thereby be protected from the outside.

In addition, the power distribution PCB 511 has positive (+) and negative (−) terminals connected to the main power line 501 and positive (+) and negative (−) terminals connected to the distribution cables 530a, 530b, and 530c and includes a parallel circuit pattern formed therebetween.

The distribution cables are integrated in the external cable jacket 520 within the molding part 512 of the distributor body 510.

As described above, the main power line 501 may be connected to the SMPS 400 which is a power supply converting external AC power into DC power.

In this case, the main power line 501 distributes the DC power from the SMPS 400 to the plurality of light emitting modules.

The external cable jacket 520 has flexibility so as to avoid interference with other components.

For example, in the case in which a large apparatus or component such as the SMPS is installed in the support frame 220, the external cable jacket 520 may be disposed to be flexed so as to avoid interference with this large component.

FIG. 18 is a diagram describing an illuminating apparatus according to another exemplary embodiment of the present invention.

According to the above-mentioned embodiment described with reference to FIG. 16, the SMPS 400 is positioned inside the support frame 220 which is a portion of the housing.

On the other hand, in the illuminating apparatus according to the present embodiment, the SMPS 400 is positioned outside the housing of the illuminating apparatus, as shown in FIG. 18.

The DC power converted from the AC power by the SMPS 400 positioned outside the housing is supplied to the distributor 500 positioned inside the support frame 220 of the housing through the main power line 501.

Since other configurations are the same as those of the above-mentioned embodiment, a description thereof will be omitted in order to avoid overlap.

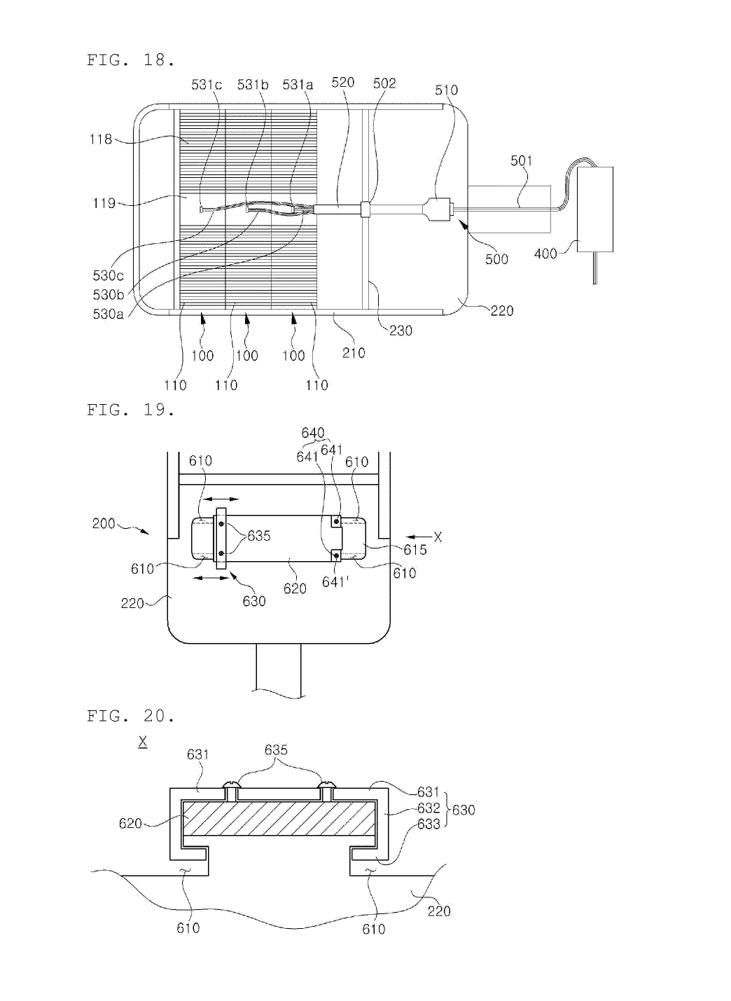

Meanwhile, in the present invention, an example of a structure in which an SMPS 620 mounted in the support 220 of the housing 200 may be fixed corresponding to various shapes and sizes of the SMPS 620 as shown in FIGS. 19 to 22 may also be applied.

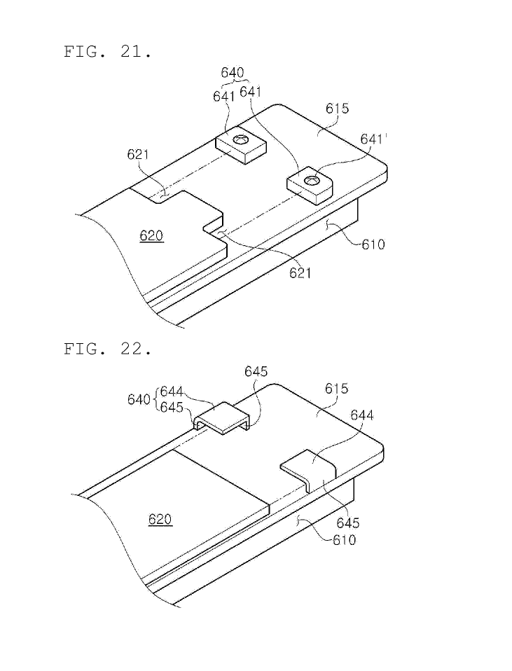

For reference, FIG. 19 is a conceptual diagram showing a coupling relationship between a bracket and an SMPS which are main parts of the optical semiconductor based illuminating apparatus according to the exemplary embodiment of the present invention; FIG. 20 is a cross-sectional view viewed from the point X of FIG. 19; and FIGS. 21 and 22 are partially exploded perspective views showing a state in which the SMPS is coupled to a fixture which is a main part of the optical semiconductor based illuminating apparatus according to various exemplary embodiments of the present invention.

A pair of rails 610 is formed on an inner surface of a support 220, the SMPS 620 is disposed at an upper portion of the rail 610, and a bracket 630 has both end portions reciprocating along the pair of rails 610 and fixes the SMPS 620.

Here, the support 220 configuring the housing 200 may further include a seat jaw 615 disposed between the pair of rails 610 and having the SMPS 620 seated thereon.

The seat jaw 615 is to provide an area allowing the SMPS 620 to be stably disposed.

Here, it may be appreciated from FIG. 20 that the rails 610 are formed along both edges of the seat jaw 615.

Meanwhile, the bracket 630 will be described in detail. The bracket 630 includes a first piece 631 contacting an upper surface of the SMPS 620, second pieces 632 extended from both end portions of the first piece 631, respectively, and third pieces 633 extended from end portions of the second pieces 632, respectively, to contact the rails 610.

In addition, the bracket 630 may further include at least one bolt 635 detachably coupled to the first piece 631 to contact or be spaced apart from the upper surface of the SMPS 620, in order to move the SMPS 620 along the rails 610 in accordance with a length of the SMPS 610 and then certainly fix the SMPS 620.

Further, the housing 200 may further include fixtures 640 formed on an inner surface of the support 220 thereof, more specifically, on the seat jaw 615 and fixing both sides of one end portion of the SMPS 620.

Here, the fixture 640 may have a structure in which it includes a pair of blocks 641 detachably coupled to the inner surface of the support 220 and having a shape corresponding to those of cut parts 621 formed at both sides of one end portion of the SMPS 620, respectively, as shown in FIG. 21.

In addition, the fixture 640 may also have a structure in which it includes fourth pieces 644 that are in parallel with the inner surface of the support 220 and disposed at both sides of one end portion of the SMPS 620, respectively, and blocking walls 645 extended to an inner side surface of the support 220 along two edges of the fourth pieces 644 meeting each other and contacting both sides of one end portion of the SMPS 620, as shown in FIG. 22.

As described above, it may be appreciated that a basic technical spirit of the present invention is to provide the optical semiconductor based illuminating apparatus capable of promoting convenience for checking and repairing, simply performing separation and fastening, having excellent waterproofing characteristics and durability, preventing accidents such as short circuit and electric shock improving heat radiation performance, preventing introduction of foreign materials, being easily cleaned and maintained, reliably providing power of a main power line to a plurality of light emitting modules, and utilizing a space and securing reliability of a product regardless of a size and a shape of a power supply embedded therein.

According to the present invention having the configuration as described above, the following effects may be accomplished.

First, according to the present invention, at least one light emitting module is detachably coupled to the housing having opened upper and lower surfaces and enclosing the edge of the light emitting module in the vertical direction of the housing, such that the separation and the fastening between the light emitting module and housing may be simply performed and action may be instantly taken at the time of generation of a fault or a malfunction, thereby making it possible to provide convenience to a worker at the time of checking and repairing by the worker.

In addition, according to the present invention, the wiring path is formed at the center of the heat sink part, and the auxiliary cover detachably coupled to the wiring path to cover the wiring path and the cover detachably coupled to the housing to cover the upper portion of the light emitting module embedded in the housing are provided, thereby making it possible to maintain waterproofing characteristics and air tightness and prevent accidents such as short circuit and electric shock.

Further, according to the present invention, the electrical connection is made by the connector capable of being detachably coupled to the semiconductor optical device disposed at the heat sink part along the above-mentioned wiring path, and the respective light emitting modules are also electrically connected to each other by this connector, such that even though a fault occurs in any one of the plurality of light emitting modules, a function of the illuminating apparatus may be sufficiently performed using the remaining light emitting modules.

In addition, according to the present invention, the cover detachably coupled to the housing while being elastically deformed is provided, thereby making it possible to easily check and repair internal components of the apparatus.

Further, according to the present invention, the cover covering the upper portion of the light emitting module is provided with the vent unit, thereby making it possible to improve heat radiation performance, preventing introduction of foreign materials, and easily perform cleaning and maintenance.

In addition, according to the present invention, the distributor in which the plurality of distribution lines are led and branched from the distributor body in which waterproofing or air tightness are ensured in a state in which they are sealed and integrated by a predetermined length section, thereby making it possible to reliably provide the power of the main power line to the plurality of light emitting modules.

Further, according to the present invention, the bracket having both end portions reciprocating along the pair of rails so as to fix the SMPS disposed at the upper portion of the pair of rails formed on the inner surface of the support is provided to be actively adapted for various sizes and shapes of the SMPS embedded in the illuminating apparatus, thereby making it possible to secure generality.

In addition, various modifications and applications may be made by those skilled in the art without departing from the scope of the basic technical spirit of the present invention.

What is claimed is:

1. An optical semiconductor based illuminating apparatus comprising:
light emitting modules including at least one semiconductor optical device; and
a housing enclosing one side surface of at least one of the light emitting modules.

2. The optical semiconductor based illuminating apparatus of claim 1, wherein the housing is separated into a plurality of components.

3. The optical semiconductor based illuminating apparatus of claim 1, wherein the light emitting module includes:
a heat sink part including the semiconductor optical device and disposed in the housing; and
an optical cover coupled to the heat sink part.

4. The optical semiconductor based illuminating apparatus of claim 1, wherein the housing includes an outer frame enclosing one side surface of at least one of the light emitting modules.

5. The optical semiconductor based illuminating apparatus of claim 4, wherein the housing further includes a support having the outer frame slidably coupled thereto.

6. The optical semiconductor based illuminating apparatus of claim 4, wherein the housing further includes fixing plates having edges of both end portions fixed to facing surfaces of the outer frame, respectively, and embedded in the outer frame to fix both edges of the light emitting module, respectively.

7. The optical semiconductor based illuminating apparatus of claim 6, wherein the light emitting modules are disposed between the fixing plates while forming one or more rows and columns.

8. The optical semiconductor based illuminating apparatus of claim 3, wherein the heat sink part includes:
a heat radiation plate having at least one semiconductor optical device formed thereon; and
a plurality of heat radiation fins formed on one surface of the heat radiation plate.

9. The optical semiconductor based illuminating apparatus of claim 3, wherein the heat sink part includes:
a heat radiation plate having at least one semiconductor optical device formed thereon;
a plurality of heat radiation thin plates disposed on the heat radiation plate; and
heat pipes penetrating through the plurality of heat radiation thin plates to thereby be connected to the heat radiation plate and forming internal channels.

10. The optical semiconductor based illuminating apparatus of claim 8, wherein the heat sink part includes a wiring path formed by a pair of partition walls protruded from the heat radiation plate.

11. The optical semiconductor based illuminating apparatus of claim 9, wherein the heat sink part includes a wiring path formed by a pair of partition walls protruded from the heat radiation plate.

12. The optical semiconductor based illuminating apparatus of claim 10, wherein the heat sink part further includes:
first grooves depressed in facing surfaces of the pair of partition walls, respectively; and
an auxiliary cover having both end portions detachably coupled to the first grooves to cover a lower portion of the wiring path.

13. The optical semiconductor based illuminating apparatus of claim 11, wherein the heat sink part further includes:
first grooves depressed in facing surfaces of the pair of partition walls, respectively; and
an auxiliary cover having both end portions detachably coupled to the first grooves to cover a lower portion of the wiring path.

14. The optical semiconductor based illuminating apparatus of claim 1, wherein one or more light emitting modules having the same size and shape are disposed so as to be in parallel with each other in the housing.

15. The optical semiconductor based illuminating apparatus of claim 6, wherein a plurality of light emitting modules are disposed so as to be in parallel with the fixing plates.

16. The optical semiconductor based illuminating apparatus of claim 12, wherein the auxiliary cover includes:
a cover piece covering the wiring path while contacting edges of upper end portions of the partition walls; and
auxiliary hooks protruded from a lower surface of the cover piece in a length direction of the cover piece and having end portions coupled to the first grooves.

17. The optical semiconductor based illuminating apparatus of claim 13, wherein the auxiliary cover includes:
a cover piece covering the wiring path while contacting edges of upper end portions of the partition walls; and
auxiliary hooks protruded from a lower surface of the cover piece in a length direction of the cover piece and having end portions coupled to the first grooves.

18. The optical semiconductor based illuminating apparatus of claim 12, wherein the auxiliary cover includes:
a cover piece contacting edges of upper end portions of the partition walls of the heat sink parts disposed in plural so as to cover the wiring path formed by the partition walls; and
auxiliary hooks protruded from a lower surface of the cover piece in a length direction of the cover piece and having end portions coupled to a plurality of first grooves formed in the plurality of partition walls.

19. The optical semiconductor based illuminating apparatus of claim 13, wherein the auxiliary cover includes:
a cover piece contacting edges of upper end portions of the partition walls of the heat sink parts disposed in plural so as to cover the wiring path formed by the partition walls; and
auxiliary hooks protruded from a lower surface of the cover piece in a length direction of the cover piece and having end portions coupled to a plurality of first grooves formed in the plurality of partition walls.

20. The optical semiconductor based illuminating apparatus of claim 5, wherein the outer frame of the housing includes side frames having second grooves formed in a length direction thereof and having a shape corresponding to those of fixing bars protruded on both side surfaces of the support.

21. The optical semiconductor based illuminating apparatus of claim 20, wherein the outer frame further includes a side bracket having a third groove formed at an upper portion of an inner side surface thereof in the length direction, a step formed at a lower portion of the inner side surface thereof, and fixing bars formed on an outer side surface thereof and corresponding to the second grooves to thereby be coupled to the side frame.

22. The optical semiconductor based illuminating apparatus of claim 21, wherein the outer frame further includes a connection frame having fixing pieces protruded from both end portions thereof, respectively, and having a shape corresponding to that of a coupling space formed by the fixing bars and the second grooves.

23. The optical semiconductor based illuminating apparatus of claim 4, further comprising a cover covering an upper portion of the light emitting module and having both end portions coupled to the outer frame.

24. The optical semiconductor based illuminating apparatus of claim 23, wherein the cover includes:
a plate covering the upper portion of the light emitting module;
connection pieces extended from both end portions of the plate and bent toward the outer frame; and
catching hooks extended from end portions of the connection pieces to thereby be detachably coupled to the third grooves.

25. The optical semiconductor based illuminating apparatus of claim 24, wherein the cover further includes reinforcing structures protruded inwardly along connection portions between the plate and the connection pieces.

26. The optical semiconductor based illuminating apparatus of claim 24, wherein the cover further includes step parts formed at lower portions of the connection pieces so as to be stepped and having upper end portions seated on edges of an upper portion of the outer frame, and
the catching hooks are formed at lower end portions of the step parts.

27. The optical semiconductor based illuminating apparatus of claim 25, wherein the reinforcing structure includes:
a body protruded from the connection portion between the plate and the connection piece; and
a hollow part cut inwardly in a length direction of the body and formed in a cylindrical shape at the center of the body to thereby be expanded or contracted according to elastic deformation of the connection piece.

28. The optical semiconductor based illuminating apparatus of claim 1, wherein the light emitting modules adjacent to each other or the outermost light emitting module and the housing are disposed so as to be spaced apart from each other.
